(19) United States
(12) Patent Application Publication
(10) Pub. No.: US 2013/0297068 A1
(43) Pub. Date: Nov. 7, 2013

(54) MEDICATION DISPENSER WITH REMINDER DEVICE

(71) Applicant: Lloyd Alan Marshall, Somerset West (ZA)

(72) Inventor: Lloyd Alan Marshall, Somerset West (ZA)

(21) Appl. No.: 13/989,286

(22) PCT Filed: Oct. 11, 2011
(86) PCT No.: PCT/IB2011/002382

§ 371 Date: Jul. 25, 2013

(30) Foreign Application Priority Data
Nov. 24, 2010 (ZA) 2010/08417

(51) Int. Cl. A61J 7/04

(52) U.S. Cl. CPC A61J 7/04
USPC 700/244

(57) ABSTRACT

A personal medication dispenser is provided that has a storage compartment (1) and a manually operable closure (2) for providing access to the storage compartment, and a microprocessor (4) together with associated electronic circuitry including a memory (5) and an electronic time clock (6), and an alarm (7) operable by the microprocessor in response to an alarm time outputted by the time clock on the basis of data in the memory. The memory retains data as to each selected time the dispenser is opened to provide access to the storage compartment during an historic period of an integral number of days with each item of retained data being identified as pertaining to a particular timeslot of a predetermined duration that is separated from any other timeslot or timeslots by a predetermined time interval. The microprocessor is arranged to cause activation of the alarm at an automatically determined alarm time that is determined on the basis of historic selected opening times within one or more different timeslots over said predetermined historic time period of days. User programmed alarm times may optionally also be provided.

### FIELD OF INVENTION

This invention relates to a personal medication dispenser or container (herein termed dispenser) that may be either free-standing or portable, and that is adapted to receive a supply of one or more medicines being taken in doses and that need to be removed from the dispenser periodically for that purpose.

More particularly, the invention relates to a medication dispenser that embodies a reminder device for reminding a user that a dose needs to be taken.

### BACKGROUND OF THE INVENTION

Medical practitioners commonly prescribe medication for the treatment of ailments suffered by patients or as a prophylactic measure against numerous different conditions or sicknesses. Most people remember to take their medication at the times prescribed by their doctor, at least initially, but as time goes by, they often forget to take at least some doses of the medication as prescribed.

Many medication dispensers having alarm based reminder devices have been proposed and some of which applicant believes are available commercially. Existing medication dispensers of this type require a user to enter their prescribed medication times via an interface which commonly includes a keypad or a number of buttons (which term is intended to include “touch” pads and other finger activated sensor arrangements) as well as a display.

Many users, in particular the frail or infirm, may have difficulty in programming these devices. This problem is made worse when a user's medication taking routine changes somewhat, typically seasonally. For example, a user may take medication in summer at 7am and in winter at 8am as a result of the fact that the sun rises later in winter. Existing medication reminder systems do not automatically adjust their alarms from season to season.

Of course, very much the same principles apply to the taking of medication over a short term, typically for one course of medication, as well as to long-term medication taken by persons that suffer from chronic conditions that require medication to be taken for extended periods of time, and sometimes for life.

### SUMMARY OF THE INVENTION

In accordance with this invention there is provided a personal medication dispenser having a storage compartment and a manually operable closure for providing access to the storage compartment, a sensor for sensing when the manually operable closure is operated, a microprocessor together with associated electronic circuitry including a memory and an electronic time clock, and an alarm operable by the microprocessor in response to an alarm time outputted by the time clock on the basis of data in the memory, the medication dispenser being characterized in that the memory retains data as to each selected time the manually operable closure has been operated to provide access to the storage compartment during an historic period of an integral number of days with each item of retained data being identified as pertaining to a particular timeslot of a predetermined duration that is separated from any other timeslot or timeslots by a predetermined time interval and in that the microprocessor is arranged to cause activation of the alarm at an automatically determined alarm time that is determined on the basis of historic selected operating times of the manually operable closure within one or more different timeslots over said predetermined historic time period of days.

It is to be noted that reference to the term time clock in this specification does not necessarily mean that any time outputted by the time clock bears any relation to real clock time in any particular geographic location unless the term real-time is used to indicate this. Any time clock employed by any embodiment of the invention may thus be used purely for the purpose of determining timeslots and time intervals relative to each other over a 24 hour time period for the purpose of determining alarm times in relation to each other as is further described herein.

Further features of the invention provide for each selected operating time of the manually operable closure to be the first operating time within any timeslot so that such selected operating time is employed for the purpose of determining an automatically determined alarm time with other occurrences of manually operable closure operating times within that timeslot not being used for the purposes of calculation of an automatically determined alarm time; for the activation of the alarm at an automatically determined alarm time to take place at a predetermined time relative to the relevant timeslot that may be a median time within the timeslot or any other time within the timeslot or even immediately after expiry of the timeslot; for each operating time of the manually operable closure that takes place during a time interval not to be used for the purposes of calculation of an automatically determined alarm time; for the predetermined duration of a timeslot to be selected from ½ hour, 1 hour, 1½ hours and 2 hours with a preference being for a duration of 1 hour or 1½ hours; for a timeslot to be defined around a selected operating time of the manually operable closure within that timeslot over the predetermined historic time period of days so that the selected operating time becomes a median time within that timeslot with the result that the timeslot in relation to real-time may vary according to the behavior of a user over a period of days, weeks or months; for the automatically determined alarm to be activated at a median time of at least plural most recently recorded times within a particular timeslot over the predetermined historic time period of days; for the time interval to be selected from ½ hour, 1 hour, 1½ hours and 2 hours with a preference being for a time interval of 1 hour; and for the predetermined historic time period of days to be selected from between 3 and 10 days with a preference being for a period of 7 days.

Still further features of the invention provide for the memory means to record a predetermined number of historic selected times within a timeslot over the predetermined historic time period of days with any new selected time recorded replacing the oldest selected time recorded in the memory such that the memory maintains the time data for a maximum of the most recent predetermined number of historic recorded selected operations within that timeslot that corresponds to the predetermined historic time period of days; and for the medication dispenser to have a USB port or other communications facility whereby it can communicate with an outside computer having a cooperating application for receiving data from the medication dispenser in which instance the application may optionally be configured to convert the selected times recorded in the memory of the dispenser to real-times in a relevant geographic location.

Yet further features of the invention provide for the medication dispenser to include an inertial sensor (that may be referred to as a vibration sensor) or accelerometer connected to the microprocessor and associated electronic circuitry; for the output from the inertial sensor or accelerometer to be connected to the microprocessor that interprets the signals according to particular types of movement to which the medication dispenser has been subjected optionally within a predetermined time period following a trigger operation of the manually operable closure; for the inertial switch or accelerometer to be operative to switch off the alarm and place the microprocessor and associated electronic circuitry in a “snooze” mode for a predetermined period of time following which the alarm is activated once more; for the medication dispenser to have an “off” condition in which the vibration sensor or accelerometer is deactivated in order to conserve power in which instance an “on” condition is adopted when an alarm time is reached, or when the manually operable closure is operated, or when a USB or other communications facility associated with the medication dispenser is operated or connected; for the alarm to be an audible alarm, a vibration style of alarm, a user operated selection of either, or both; and for the micro processor to be provided with an algorithm for determining its operation.

It is an important feature of this invention that the automatically determined alarms that result from normal use of the medication dispenser as defined above can be overridden or supplemented with manually set alarms that are, in the event of an inertial switch or accelerometer being included in the circuit, preferably activated by manipulating the medication dispenser, especially including the step of shaking it until a characteristic activation response is given. Such manually set alarms can be deactivated by repeating the procedure after which a characteristic deactivation response is given and any manually set alarms within one hour of the time of deactivation are cancelled.

Of course, the medication dispenser may have an additional or alternative interface in the form of, for example, one or more pushbuttons (which term includes a “touch” pad and any other finger activated sensor arrangement) for operation when a particular alarm time is to be cleared or, alternatively, a signal such as opening of the lid when an alarm has been triggered momentarily or at least typically for less than say about 2 seconds or any other time period that would be insufficient to enable medication to be removed from the compartment. Such an interface may also be used for the purpose of manually entering a “snooze” mode should an alarm be triggered.

There may however be no finger operated pushbutton or the like and the entire control of the medication dispenser may be interfaced by way of operating the manually operable closure in a particular manner and moving the medication dispenser in a particular manner. In such an instance one or two LEDs could be employed for indicating particular situations or conditions of the circuitry and recognition of a particular “instruction” could be given by means of a particular type of audible signal characteristic of the instruction received or by characteristic flashing of one or more LEDs.

Yet other features of the invention provide for the medication dispenser to be a box with one or more compartments for receiving medication in dosage unit form in which instance the closure is conveniently a lid for the box; and for the sensor to include a switch, preferably a magnetically operated micro-switch, associated with the box and lid.

Whilst the medication dispenser of the invention could be configured to dispense predetermined quantities of liquid or semi-liquid preparations from a bulk supply thereof, it is envisaged that it will most commonly be used for the purpose of dispensing medication in unit dosage form, such as pills, capsules, dragees and suppositories.

In order that the invention may be more fully understood one embodiment thereof will now be described with reference to the accompanying drawings.

### BRIEF DESCRIPTION OF THE DRAWINGS

In the drawings:

FIG. 1 is a perspective illustration of one embodiment of medication dispenser according to the invention in the open condition;

FIG. 2 is the same but illustrates an alternative interface on the outside of the medication dispenser;

FIG. 3 is schematic plan view thereof;

FIG. 4 is a schematic cross-section thereof; and,

FIG. 5 is block diagram of the electronic circuit of this embodiment of medication dispenser.

### DETAILED DESCRIPTION WITH REFERENCE TO THE DRAWINGS

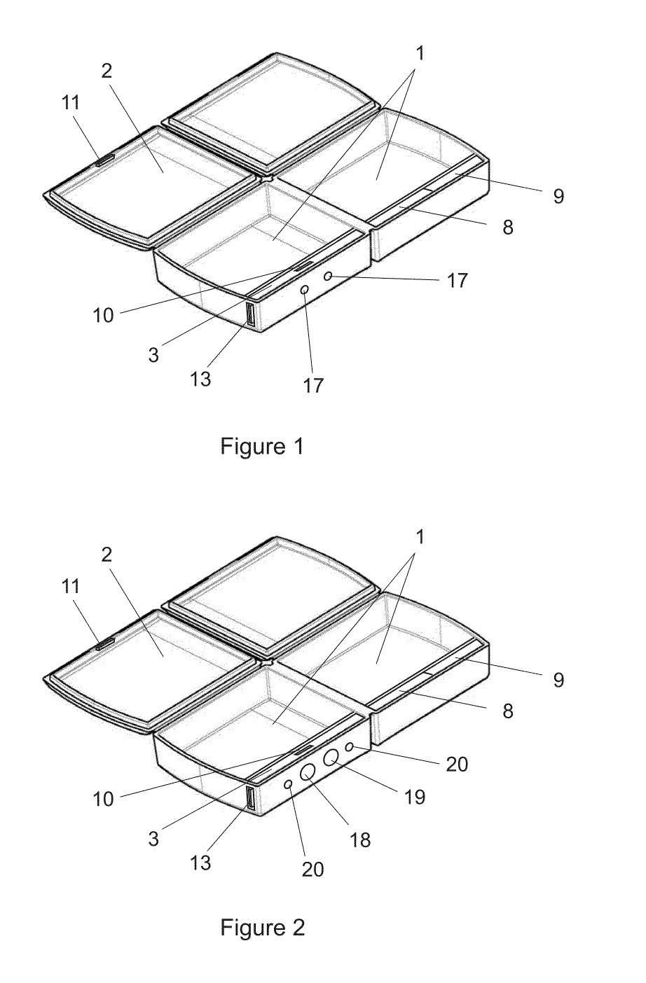

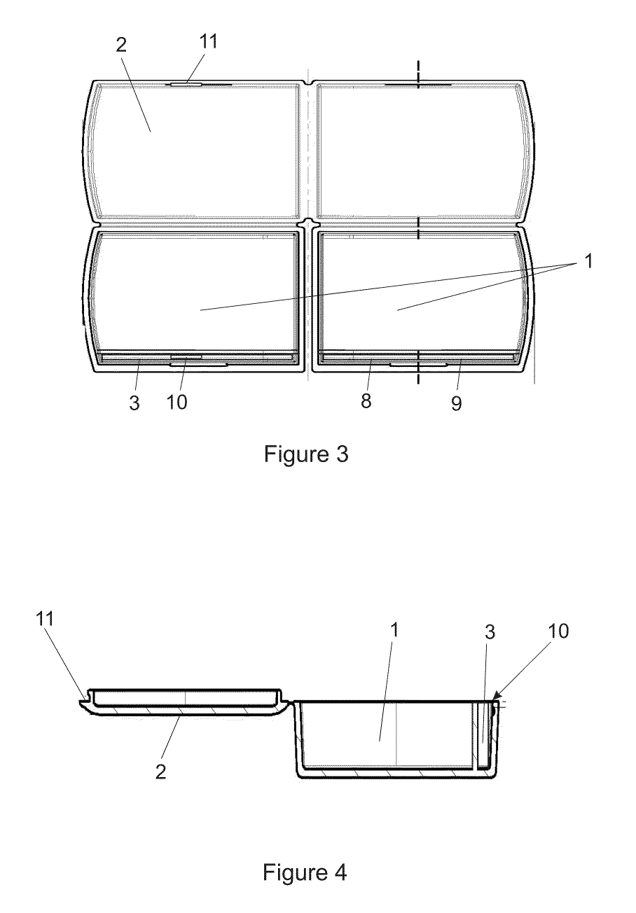

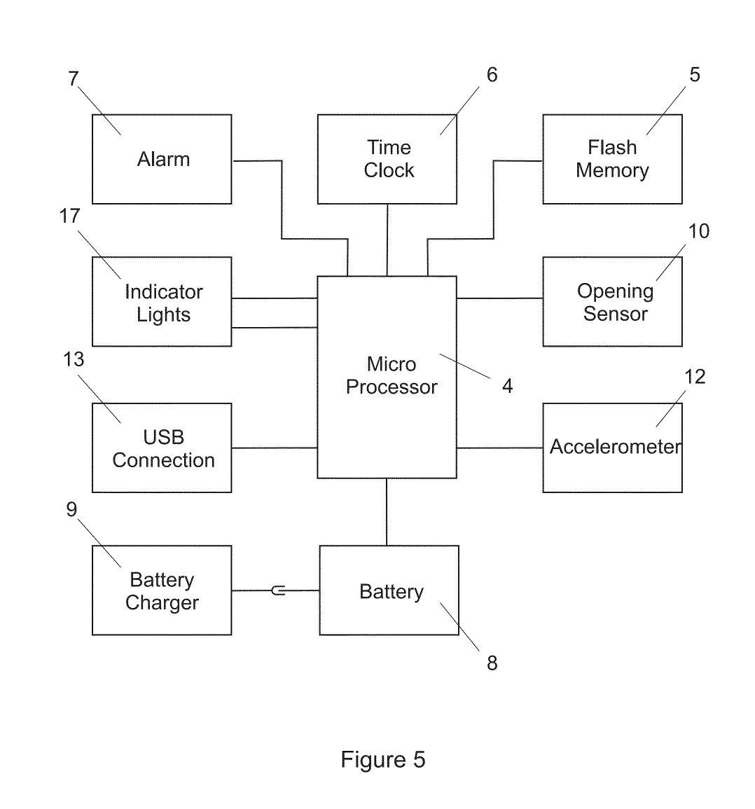

In the embodiment of the invention illustrated in the drawings, the variations of the embodiment of the invention illustrated in FIGS. 1 and 2 of the accompanying drawings differ only in the interface for communicating with the electronic circuitry and, accordingly, like components will be given the same reference numerals in both.

In the illustrated embodiment of the invention, a personal medication dispenser is in the form of a box having, in this particular instance, two storage compartments (1) that could, for example, be used to store two different medications. Of course, the box may consist of a single storage compartment or may have a greater number of storage compartments, such as seven representing one for each day of the week. The box is made of a moulded plastic material and has an integral lid (2) for closing it and connected to the box by an integral thin web of material that becomes flexible by virtue of its reduced thickness, in well-known manner.

A small circuit board (3) is housed within a double wall at one extremity of the compartment, in this instance, the front. With reference particularly to FIG. 4 of the drawings, the circuit board has a microprocessor (4) and associated electronic circuitry including a memory in the form of a flash memory (5) and an electronic time clock (6).

An alarm in the form of a suitable audio transducer (7) is provided for activation by the micro-processor in a manner that will become more apparent from the following.

A battery (8) is provided for energizing the entire circuit and a battery charging circuit (9) is built in so that the battery can be charged periodically, as may be necessary.

Also carried on the circuit board is a magnetically operated switch (10) with a cooperating magnet (11) being carried by the lid so that the switch is operated each time the lid is opened.

An accelerometer (12) is also provided on the circuit board, the accelerometer preferably being of the microelectromechanical systems (MEMS) type. Of course, any other suitable accelerometer, inertial switch, or vibration switch can be employed according to requirements.

A USB connection socket (13) is provided whereby the entire electronic circuit can be connected to an external computer either for the purpose of programming the microprocessor or for the purpose of downloading data resident in the flash memory. Any other communications facility may also be provided including a wireless communications facility.

Of course, the electronic circuitry may be provided with the usual low battery warning facility that is not further described herein as well as further controls according to requirements.

The flash memory is in the form of a buffer that records the selected time of each instance that the lid is opened on the basis that, when the buffer is full, the data pertaining to the earliest selected opening occurrence is deleted and replaced by the data pertaining to the latest one. The memory is thus arranged to retain data as to each selected time the lid has been opened to provide access to medication stored in the storage compartment with each item of data being identified as pertaining to one of a plurality of different timeslots. The memory means is adapted to record a predetermined number of historic times within a timeslot such that the memory maintains the time data for a predetermined number of selected operations, typically a number corresponding to an overall time period of, in this instance, 7 days. Of course the overall time period may be longer or shorter according to requirements.

It is preferred that a timeslot endure a period of 1 hour although other time periods may be employed, as indicated above. As it is envisaged that medication would only be taken once in a period of one hour, only the first occurrence of opening of the box becomes a selected opening time with subsequent opening times of the box within the same timeslot being rejected. Another timeslot cannot be commenced before a predetermined time interval has expired after termination of a timeslot and whilst that time interval could be relatively short, it is presently preferred to also make it 1 hour. Any occurrences of opening of the box that take place during the predetermined time interval are also rejected.

The microprocessor is programmed with an algorithm that ensures the proper operation of the device and that is arranged to activate the audio transducer at times of day determined on the basis of the median time of multiple historic operating times of the most recent selected daily opening times within a particular timeslot on the days within a predetermined historic time period of days that, in the present instance, is a period of 7 days. The processor thus follows the behavior of a user by recording when the user most often opens the container for the first time in a particular timeslot that is taken to be to the time of removal of medication up to a maximum of 7 days. The audio transducer is activated as a reminder in the event that a user fails to open the box appropriately for the removal of medication. The audio transducer is not activated if the user has accessed the box within the relevant timeslot which would indicate the relevant dose of medicine has been taken.

It is to be noted that the various timeslots may be predetermined and programmed into the microprocessor and memory or, alternatively, they may be generated in response to repeated selected times of opening of the dispenser in a manner consistent with the removal of medication. A timeslot may extend for a half an hour on each side of a median selected opening time at a particular general time of the day, typically early morning, lunchtime and evening, although certain types of medication may need to be taken more often. With the use of a timeslot having a duration of 1 hour, and a time interval of 1 hour between successive timeslots, a maximum number of 12 timeslots is possible within a 24 hour time period, and it is envisaged that this would generally be more than sufficient as most medication is only taken once, twice or three times per day and possibly up to five times a day.

Turning now to the function of the accelerometer, it may be used by a user to switch off the audio transducer simply by moving the dispenser in a particular way such as turning it upside down, or on its side when the alarm is active. This movement may be programmed to place the microprocessor and associated electronic circuitry in a “snooze” mode for a predetermined period of time, typically 5 or 10 minutes, following which the alarm may be activated once more. This procedure may be repeated up to four or five times.

It will be understood that in use, the medication dispenser described above can be used as outlined hereinbefore by a user simply storing medication within the dispenser and withdrawing it whenever a dose is necessary. Over a period of days the data stored in relation to the times at which medication was taken will, after at least 2 days, give rise to the development of automatic alarm times that will be activated if the user omits to take the relevant medication before a predetermined time which could, for example, be the median time of a timeslot; the end of the timeslot; after the expiry of two thirds of the timeslot; or immediately following termination of a timeslot. The timeslots will be automatically set up around the medication taking times with the selected time being “averaged” over the recorded preceding days up to the predetermined number of historic times within a timeslot that in this instance is 7 days. Thus, medicine taken on successive days at 06h49, 07h10, 07h05, 06h56, 07h15, 07h08, 06h51 give rise to a median automatic alarm time of 07h02 and a time slot that endures from 06h32 to 07h32. Similar calculations would take place in respect of all other medicine taking times that fall outside of the 1 hour time interval that follows any timeslot.

In one simple form of this embodiment of the invention, the medication dispenser could be just as described above.

However, whilst not being essential to the invention, in a more advanced version of this particular embodiment of the invention, user programmed alarms are also available with user programmed alarms generally taking precedence over, and de-activating, automatically determined alarm times in the relevant timeslot.

Setting of a user programmed alarm may take place by manipulating the box in a pre-determined way such as by opening the box momentarily and closing it which causes an LED (17) (see FIG. 1) to flash slowly for 5 seconds and then immediately shaking the dispenser about 5 times while the LED is still flashing. Pulses given out by the accelerometer in consequence of the shaking are sensed by the electronic circuit and when the shaking action is recognised, a distinctive activation multi tone is played by the audio transducer. The dispenser thus senses that a shake has happened and programs a user programmed alarm at that time. This user programmed alarm takes precedence over all alarms that are stored in the relevant timeslot in which it is set, or it can create its own timeslot, as the case may be, although it does not necessarily need to be linked to any timeslot. An alarm is thus set at the activation time to go off every day.

A user programmed alarm may be deactivated in the same way, by using the shaking routine of the device, and when the shaking action is recognised, a distinctive deactivation mono tone is played by the audio transducer. Such deactivation is designed to cancel out any user programmed alarm within a half an hour on each side of the deactivation time. Automatically set alarms could also be deactivated in the same way if the deactivation procedure is carried out at an appropriate time in relation to a timeslot.

In this more sophisticated version of this embodiment of the invention, a user could, for example, program the medication dispenser to provide an alarm every morning at a suitable time that would allow the user to take the medication and reach a public transport stop at a regular time. Other medication times, if any, could be set automatically as would be quite clear from the foregoing.

As an alternative control means to the shaking procedure indicated, and as shown in FIG. 2, there may be provided a pushbutton (18) on the outside of the box for the purpose of controlling the microcontroller manually such as in order to enter a “snooze” mode once the alarm has been triggered or to activate and deactivate alarm times whether they be automatically or user programmed.

Thus, when a particular medication is no longer required to be taken in a particular timeslot the processor and memory may be cleared of the stored medication alarm time that is scheduled for that timeslot. The “clear” function may be activated by opening and then immediately closing the dispenser within one or 2 seconds when the relevant alarm is given and then manipulating the pushbutton in a particular way in well known manner. For example, a single press could activate the “snooze” function and depressing the button for 3 or more seconds could activate the “clear” function. Alternatively, another pushbutton (19) may be provided for the purpose of clearing the memory relating to a particular time slot.

Feedback to a user can be provided by means of an audio tone and/or flashing of LEDs (light emitting diodes) (20) visible on the outside of the dispenser. Thus, when a user activates the “clear” function a special tone may be played by the processor to indicate that the alarm for the current time slot has been removed and one or other LED may flash in a characteristic manner.

It is preferred that the medication dispenser has a power saving “off” condition in which the accelerometer is deactivated in order to conserve power. In such an instance an “on” condition is adopted when an alarm time is reached and that condition is maintained until the dispenser is opened in a manner consistent with removal of medication, or until such time as the alarm is cancelled for that particular time slot. The “on” condition will also be adopted if communication with a computer is established.

By recording recent medication taking behavior of the user this medication dispenser can reinforce this behavior and prompt the user if they forget to take a dose of medication. This may be achieved without the user needing to program the unit in any way. The user simply needs to use the medication container and react to any alarm.

1. A personal medication dispenser having a storage compartment and a manually operable closure for providing access to the storage compartment, a sensor for sensing when the manually operable closure is operated, a microprocessor together with associated electronic circuitry including a memory and an electronic time clock, and an alarm operable by the microprocessor in response to an alarm time outputted by the time clock on the basis of data in the memory, wherein the memory retains data as to each selected time the manually operable closure has been operated to provide access to the storage compartment during an historic period of an integral number of days with each item of retained data being identified as pertaining to a particular timeslot of a predetermined duration that is separated from any other timeslot or timeslots by a predetermined time interval and wherein the microprocessor is arranged to cause activation of the alarm at an automatically determined alarm time that is determined on the basis of historic selected operating times of the manually operable closure within one or more different timeslots over said predetermined historic time period of days.

2. A personal medication dispenser as claimed in claim 1 in which each selected operating time of the manually operable closure is the first operating time within any timeslot so that such selected operating time is employed for the purposes of determining an automatically determined alarm time with other occurrences of manually operable closure operating times within that timeslot not being used for the purposes of calculation of an automatically determined alarm time.

3. A personal medication dispenser as claimed in claim 1 in which the predetermined duration of a timeslot is selected from ½ hour, 1 hour, 1½ hours and 2 hours.

4. A personal medication dispenser as claimed claim 1 in which a timeslot is defined around a selected operating time of the manually operable closure within that timeslot over the predetermined historic time period of days so that the selected operating time becomes a median time within that timeslot.

5. A personal medication dispenser as claimed in claim 1 in which an automatically determined alarm is activated at a median time of at least plural most recently recorded times within a particular timeslot over the predetermined historic time period of days.

6. A personal medication dispenser as claimed in claim 1 in which the predetermined historic time period of days is selected from between 3 and 10 days.

7. A personal medication dispenser as claimed in claim 1 in which the medication dispenser has a communications facility (13) whereby it can communicate with an outside computer having a cooperating application for receiving data from the medication dispenser.

8. A personal medication dispenser as claimed in claim 1 in which the medication dispenser includes an inertial sensor or accelerometer (12) connected to the microprocessor and associated electronic circuitry.

9. A personal medication dispenser as claimed in claim 8 in which an output from the inertial sensor or accelerometer is connected to the microprocessor that interprets the signals according to particular types of movement to which the medication dispenser is subjected.

10. A personal medication dispenser as claimed in claim 1 in which the micro processor is provided with an algorithm for determining its operation.

11. A personal medication dispenser as claimed in claim 1 in which an automatically determined alarm that results from normal use of the device can be overridden or supplemented with a manually set alarm.

12. A personal medication dispenser as claimed in claim 11 in which an inertial switch or accelerometer is included in the circuit and a manually set alarm may be activated or deactivated by manipulating the medication dispenser until a characteristic response is given.

13. A personal medication dispenser as claimed in claim 1 in which a user interface includes one or two LEDs for indicating particular situations or conditions of the circuitry and recognition of an “instruction”.

14. A personal medication dispenser as claimed in claim 1 in which the medication dispenser is a box with one or more compartments for receiving medication in dosage unit form in which instance the closure is a lid for the box and the sensor includes a switch associated with the box and lid.
